(19) United States
(12) Patent Application Publication
(10) Pub. No.: US 2006/0236042 A1
(43) Pub. Date: Oct. 19, 2006

(54) Training sequence for deswizzling signals

(76) Inventors: Sandeep Jain, Milpitas, CA (US); John Halbert, Beaverton, OR (US); Nilesh V. Shah, Folsom, CA (US)

Correspondence Address: MARGER JOHNSON & MCCOLLOM, P.C., 210 SW MORRISON STREET, SUITE 400, PORTLAND, OR, 97204, US

(21) Appl. No.: 11/096,271

(22) Filed: Mar. 31, 2005

(51) Int. Cl. G06F 13/00

(52) U.S. Cl. 711/154

(57) ABSTRACT

Data is transmitted from a memory device along with a training sequence to deswizzle the data. The training sequence may be sent, for example, when the memory device is initialized, or it may be appended to the data. A memory controller may include logic to receive the data and training sequence and deswizzle the data in response to the training sequence to identify the location of data on various signal lines. Other embodiments are described and claimed.

### BACKGROUND

FIG. 1 illustrates a prior art memory system having a memory controller 10, a memory connector 12 and a memory module 14 that is populated with multiple memory devices 16. The memory controller is typically part of a microprocessor or chipset residing on a computer mother board. The memory devices 16 may be fabricated directly on the mother board, but to allow for expansion, upgrade, service, and other considerations, they are commonly located on one or more modules that plug into connectors on the mother board.

In the system of FIG. 1, the signal lines D0-D3 are routed in a straightforward manner between the corresponding terminals on the controller, connector, module and memory devices. Such routing, however, may be difficult to achieve, especially as memory systems use ever increasing numbers of signal lines and memory devices.

To ease the signal routing requirements in memory systems, the signal lines may be swizzled as shown in FIG. 2. For example, the signal D2 originating at the memory controller is routed through the terminal for D1 on the connector and ends up at the terminals for signal D0 on the memory devices. Although less common, the signals lines may also be swizzled between the individual memory devices as shown by the broken lines in FIG. 2.

In a system having memory devices that only handle read/write data, e.g., dynamic random access memory (DRAM), the memory controller may be oblivious to the swizzled signal lines because data that was written to the memory devices is automatically deswizzled when it is read back to the memory controller. That is, even though data sent out from the controller on the terminals for D0, D1, D2, and D3 travels through convoluted signal paths so that it ends up being written to the locations designed D3, D1, D0, D2, respectively, at the memory devices, it traverses the same signal paths in the reverse order during a read operation, so it ends up at the controller at the correct terminals. Thus, the controller need not be aware of which signal lines on the memory devices correspond to which signal lines on the controller.

### BRIEF DESCRIPTION OF THE DRAWINGS

FIG. 1 illustrates a prior art memory system.

FIG. 2 illustrates a prior art memory system having swizzled signal lines.

FIG. 3 illustrates an embodiment of a training sequence of patterns according to the inventive principles of this patent disclosure.

FIG. 4 illustrates another embodiment of a training sequence of patterns according to the inventive principles of this patent disclosure.

FIG. 5 illustrates another embodiment of a training sequence of patterns according to the inventive principles of this patent disclosure.

FIG. 6 illustrates an embodiment of a memory system according to the inventive principles of this patent disclosure.

FIG. 7 illustrates an example embodiment of logic for generating and transmitting read-only temperature data and training sequences according to the inventive principles of this patent disclosure.

FIG. 8 illustrates an embodiment of logic for receiving and deswizzling read data from a memory device according to the inventive principles of this patent disclosure.

FIG. 9 illustrates an embodiment of deswizzle logic according to the inventive principles of this patent disclosure.

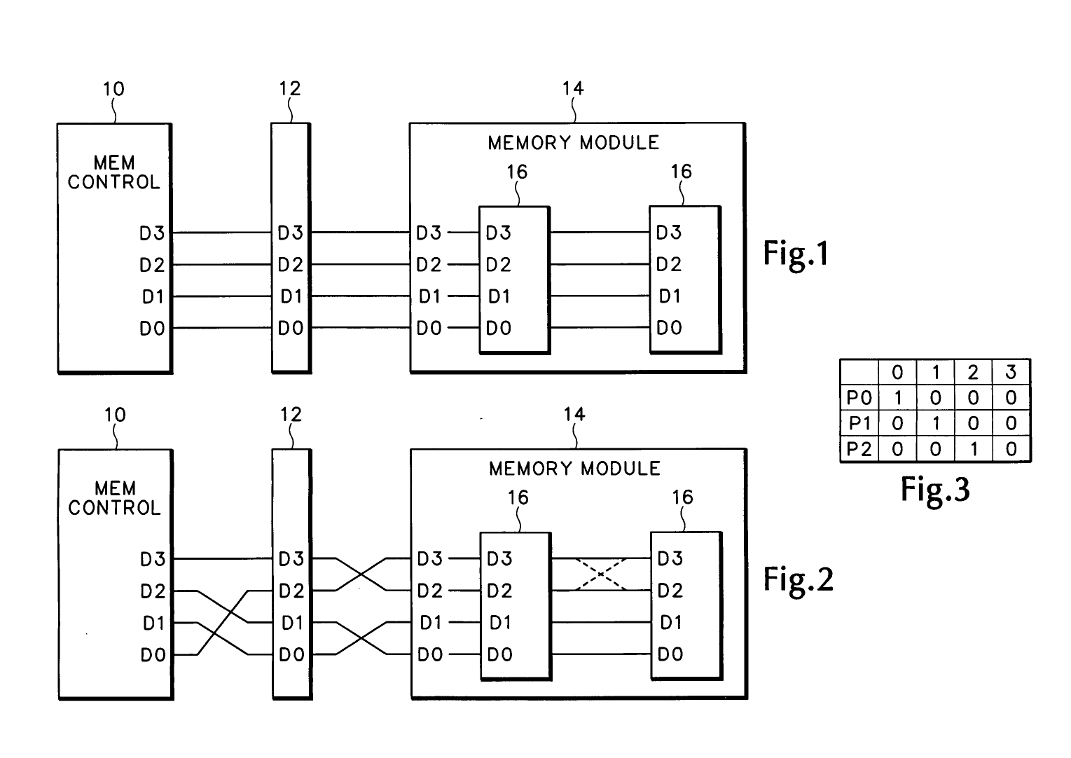

### DETAILED DESCRIPTION

This patent disclosure encompasses numerous inventions that have independent utility. In some cases, additional benefits may be realized when some of the principles are utilized in various combinations with one another, thus giving rise to additional inventions. These principles may be realized in countless embodiments. Although some specific details are shown for purposes of illustrating the inventive principles, numerous other arrangements may be devised in accordance with the inventive principles of this patent disclosure. Thus, the inventive principles are not limited to the specific details disclosed here.

### Training Sequence For Deswizzling Signals

Although a memory controller need not be aware of swizzled signal lines when working with read/write data, swizzled signal lines may be problematic for data that originates at devices other than the controller. For example, the memory devices 16 in FIG. 2 may generate temperature data that is transmitted to the memory controller for thermal management purposes. Such data is read-only data from the perspective of the memory controller because the controller did not transmit the data to the memory device. Without knowing if and how the signal lines are swizzled, the data arrives jumbled at the controller which does not know how to interpret the data received on the signal lines D0-D3.

In a memory system according to the inventive principles of this patent disclosure, a deswizzling training sequence of may be sent so that the controller may identify the location of data on the various signal lines. For example, FIG. 3 illustrates an embodiment of a training sequence having training patterns P0, P1, and P2 for deswizzling four binary value bit lines in a memory system. Pattern P0, which has a logic 1 in the first bit position DQ[0], and logic Os in the other three bit positions DQ[1-3], is sent first to the memory controller. By looking for the only bit line with a logic 1, the controller is able to identify which line is associated with the first bit of data. Patterns P1 and P2 are transmitted next to allow the controller to identify bit positions DQ[1] and DQ[2], respectively. A fourth pattern is not necessary because the remaining bit must be DQ[3].

For a module having X4 devices, the same pattern may be repeated for all devices on one rank of the module. For device level swizzling with no swizzling between the individual memory devices, the decoding may be done in parallel for all devices. However, if there is cross-device swizzling, a longer training pattern may be used.

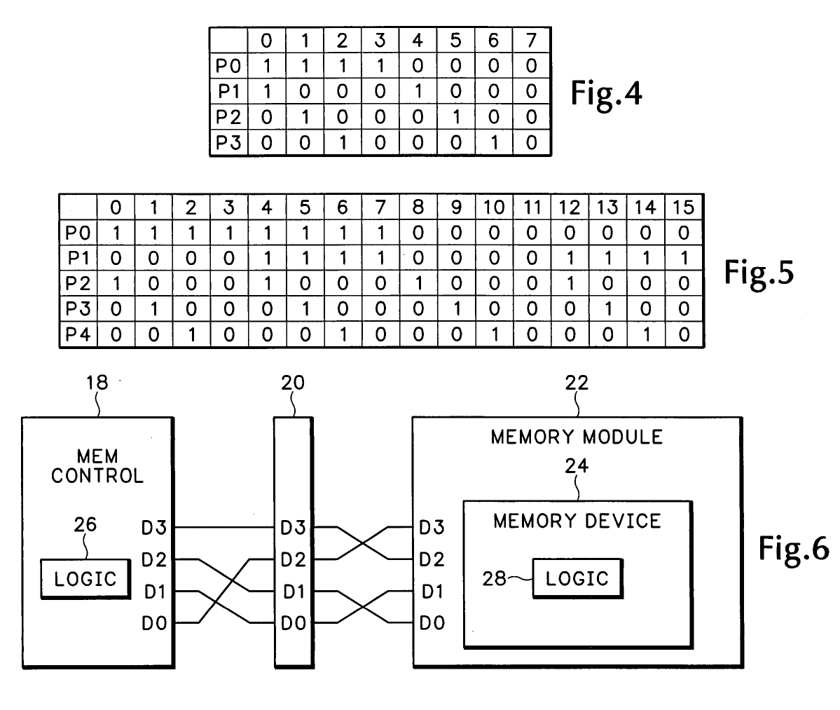

FIG. 4 illustrates another embodiment of a deswizzling training sequence according to the inventive principles of this patent disclosure. The embodiment of FIG. 4, which, for purposes of illustration, enables deswizzling of eight bit lines in a memory system, utilizes different types of training patterns to identify groups of signal lines, and to identify individual signal lines within those groups. The first pattern P0 has logic 1s in bit positions 0-1 and logic 0s in bit positions 3-7. Pattern P0 may be used to identify the locations of the signals in the upper and lower four-bit nibbles, i.e., DQ[3:0] and DQ[7:4]. Then, patterns P1 through P3, which only have a logic 1 in one bit position per nibble, are used to identify the locations of the individual bits within each nibble. This embodiment may thus allow deswizzling at the X8 device level.

FIG. 5 illustrates another embodiment of a deswizzling training sequence according to the inventive principles of this patent disclosure. The embodiment of FIG. 5 allows deswizzling at the X16 device level. Pattern P0 identifies the upper and lower eight-bit byte locations DQ[15:8] and DQ[7:0]. Pattern P1 identifies the nibbles within each byte, and patterns P2 through P4 identify the individual locations within each nibble.

FIG. 6 illustrates an embodiment of a memory system according to the inventive principles of this patent disclosure. In the system of FIG. 6, a memory device 24 includes logic 28 to generate and transmit read-only data, and to transmit a training sequence to allow deswizzling of any signal lines that may be swizzled between the memory device and the memory controller 18. Read-only data refers to any data that was not written to memory from the apparatus that is now attempting to read the data, i.e., data that is not automatically deswizzled by virtue of traversing the swizzled signal paths in the reverse direction. The memory controller includes logic 26 to derive swizzle information from the training sequence and to deswizzle data on the incoming signal lines. The embodiment of FIG. 6 is shown with four swizzled signal lines, but the inventive principles of this patent disclosure apply to systems having any number of swizzled (or potentially swizzled) signal lines. For double data rate (DDR) technology, DQ[63:0] may normally be connected to one channel of a DRAM module to the memory controller, and the P0 pattern may be different for all device configurations and can be used by the controller to know how long the training sequence will be. Likewise, memory module 22 is shown having only a single memory device, but the inventive principles apply to systems having any number of memory devices arranged individually or in stacks, behind buffers, on different modules, etc.

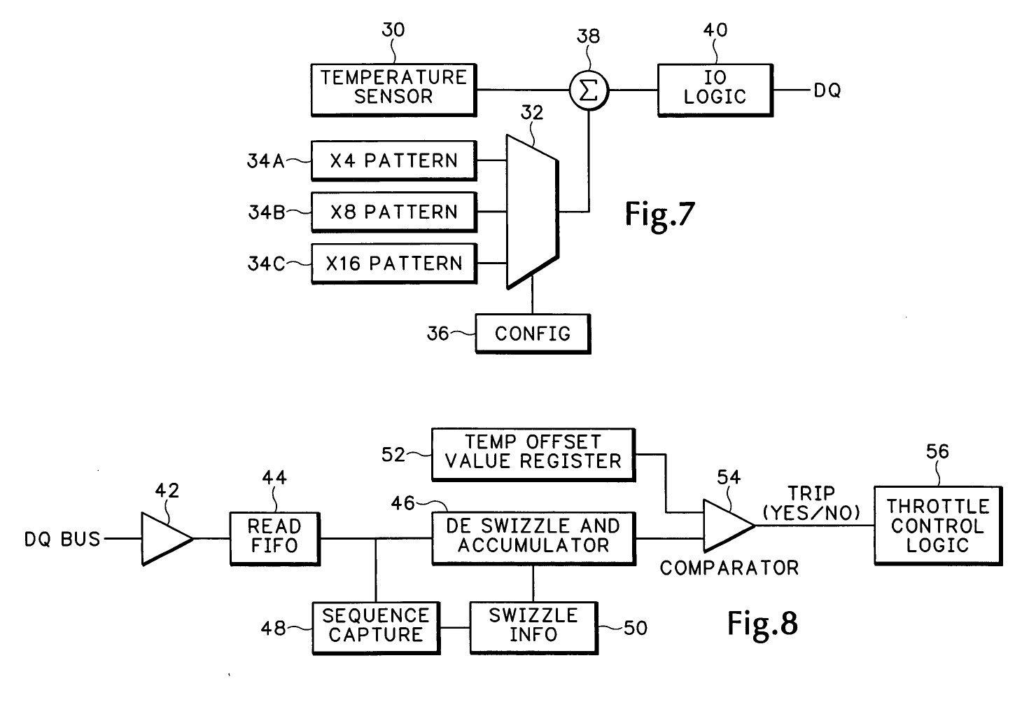

FIG. 7 illustrates an example embodiment of logic for generating and transmitting read-only temperature data and training sequences according to the inventive principles of this patent disclosure. A temperature sensor 30 generates temperature data based on the temperature of a memory device, memory module, or other apparatus. A multiplexer 32 selects a sequence of training patterns 34A-C depending on the arrangement of memory devices, e.g., X4, X8, X16, etc. A configuration register 36 stores configuration information that the multiplexer uses to determine which training sequence to select. Appending logic 38 appends the selected training sequence to the temperature data which is then transmitted through I/O logic 40. In one embodiment, the training sequence may be appended and transmitted whenever temperature data is transmitted. Alternatively, the training sequence may instead be transmitted every time a memory device or module is initialized.

The embodiment of FIG. 7 may be adapted for use as the logic 28 in the memory device 24 of FIG. 6. The placement of components is not limited to any particular arrangement. For example, all of the components may be located on one memory device. Alternatively, some of the components may be located on a memory device with the remainder residing on a memory module.

FIG. 8 illustrates an embodiment of logic for receiving and deswizzling read data from a memory device according to the inventive principles of this patent disclosure. Data is received on a signal bus DQ, and after making its way through a buffer 42 and first-in-first-out (FIFO) memory 44, arrives at a deswizzler and accumulator 46. To implement a deswizzling operation, the embodiment of FIG. 8 includes a register 48 that captures training sequences which have been swizzled (or perhaps, deswizzled) by the signal paths between it and the source of the training sequence. Logic 50 processes the patterns in the swizzled training sequence to derive swizzle information that may be used to deswizzle subsequent data.

The embodiment of FIG. 8 may be adapted for use as the logic 26 in memory controller 18 of FIG. 6, for example, to deswizzle temperature data from a memory device. Thus, it also includes a register 52 for storing a temperature offset value, and a comparator 54 for comparing the stored temperature offset value to the actual temperature data. The result of the comparison operation is a yes/no trip signal that may be used by throttle control logic 56 for thermal management purposes.

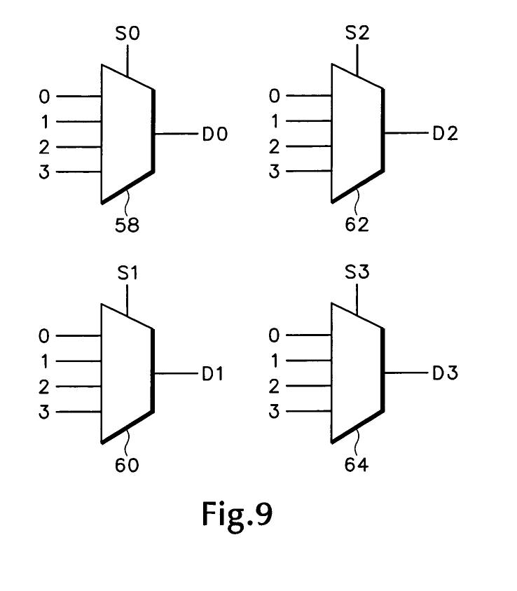

FIG. 9 illustrates an embodiment of deswizzle logic suitable for use with the embodiment of FIG. 8 according to the inventive principles of this patent disclosure. Multiplexers 58, 60, 62, and 64 may selectively connect data from any of four signal paths 0-3 to deswizzled data lines D0 through D3. The multiplexers are controlled by select signals S0 through S3 which are generated in response to the swizzle information derived by logic 50 in the embodiment of FIG. 8. For purposes of illustration, the embodiment of FIG. 9 is shown as four-bit deswizzle logic, but the inventive principles are applicable to other configurations, and the logic can be optimized for other devices as well.

The embodiments described herein may be modified in arrangement and detail without departing from the inventive principles. For example, the components need not be implemented in a module configuration with connected, but instead could be fabricated directly on a mother board. As another example, the techniques disclosed above for deswizzling “data” signals may also be used for address and command signals as well as status and any other types of signals. As yet another example, logic that may have been shown implemented in hardware, e.g., the logic shown in FIG. 7, need not necessarily be implemented as hardware, but may be amenable to software implementation as well. Accordingly, such changes and modifications are considered to fall within the scope of the following claims.

1. A method comprising:
transmitting data from a memory device; and
transmitting a training sequence to deswizzle the data.

2. The method of claim 1 where the training sequence is generated at the memory device.

3. The method of claim 1 where the training sequence is generated at a module comprising the memory device.

4. The method of claim 1 where the training sequence is transmitted by the memory device.

5. The method of claim 1 where the training sequence is transmitted by a module comprising the memory device.

6. The method of claim 1 where the training sequence is transmitted when a memory device is initialized.

7. The method of claim 1 where the training sequence is appended to the data.

8. The method of claim 1 where the data comprises temperature data.

9. The method of claim 1 where the training sequence comprises patterns to identify individual signal lines

10. The method of claim 1 where the training sequence comprises patterns to identify signal line groups.

11. The method of claim 10 where the signal line groups comprise nibbles.

12. The method of claim 10 where the signal line groups comprise bytes.

13. The method of claim 1 further comprising:
receiving the data and training sequence at a memory controller; and
deswizzling the data in response to the training sequence.

14. The method of claim 13 where deswizzling the data in response to the training sequence comprises:
capturing the training sequence; and
deriving a swizzle pattern from the training sequence.

15. Apparatus comprising:
a memory device;
logic to:
transmit data from a memory device; and
transmit a training sequence to deswizzle the data.

16. The apparatus of claim 15 where the logic comprises append logic to append the training sequence to the data.

17. The apparatus of claim 15 where the logic comprises a multiplexer to select a training sequence in response to configuration information.

18. The apparatus of claim 15 where some or all of the logic is fabricated on a memory device.

19. The apparatus of claim 15 where some or all of the logic is fabricated on a memory module.

20. The apparatus of claim 15 further comprising a memory controller coupled to the memory device and comprising logic to:
receive the data and training sequence; and
deswizzle the data in response to the training sequence.

21. The apparatus of claim 20 where the logic to receive and deswizzle the data comprises logic to:
capture the training sequence; and
derive swizzle information from the training sequence.

22. A memory controller comprising logic to:
receive data from a memory device; and
deswizzel the data in response to a training sequence.

23. The memory controller of claim 22 where the logic to receive and deswizzle the data comprises:
a register to capture the training sequence; and
logic to derive swizzle information from the training sequence.

24. The memory controller of claim 22 where the logic to receive and deswizzle the data comprises one or more multiplexers to selectively couple data from one of multiple signal lines to a single line in response to swizzle information.
